(19) United States
(12) Patent Application Publication
(10) Pub. No.: US 2019/0322915 A1
(43) Pub. Date: Oct. 24, 2019

(54) RESIN BONDED-ABRASIVE ARTICLE HAVING MULTIPLE COLORS

(71) Applicant: 3M INNOVATIVE PROPERTIES COMPANY, St Paul, MN (US)

(72) Inventors: Siriporn Jiwpanich, Huaykhwang (TW); Loc X. Van, Woodbury, MN (US); Namhyuk Kim, Gyeonggi-do (KR); Louis S. Moren, Oakdale, MN (US); Alice B. Moris, Dresser, WI (US); Maiken Givot, St. Paul, MN (US)

(21) Appl. No.: 16/472,245

(22) PCT Filed: Dec. 13, 2017
(86) PCT No.: PCT/US2017/066162

§ 371 Date: Jun. 21, 2019

Related U.S. Application Data
(60) Provisional application No. 62/437,849, filed on Dec. 22, 2016.

(51) Int. Cl. C09K 3/14; B24D 3/20; B24D 7/14; B24D 18/00

(52) U.S. Cl. CPC C09K 3/1436; B24D 18/0009; B24D 7/14; B24D 3/20

(57) ABSTRACT

Various embodiments disclosed relate to a composite abrasive article. The article can be formed from a first portion having a first color and a second portion of the article having a second color different than the first color.

### BACKGROUND

Bonded abrasive articles have abrasive particles bound together via a bonding medium. The bonding medium can be an organic resin or an inorganic material such as a ceramic, glass (e.g., vitreous bonds), or metal. Examples of bonded abrasive articles include stones, hones, and abrasive wheels such as, for example, grinding wheels and cut-off wheels.

Grinding wheels can have various shapes and may be, for example, driven by a stationary-mounted motor such as, for example, a bench grinder, or a hand-operated portable grinder. Hand-operated portable grinders can be held at a slight angle relative to the workpiece surface, and may be used to grind, for example, welding beads, flash, gates, and risers of castings.

### SUMMARY OF THE DISCLOSURE

In various embodiments the present invention provides a composite abrasive article. The article includes a first portion having a first color. The article includes a second portion having a second color different than the first color.

Various embodiments provide a method of forming a composite abrasive article. The method includes obtaining a first mixture having a first plurality of particles, an organic binder, and a first coloring element having a first color. The method further includes contacting the first mixture with a mold. The mold is then pressed, to provide the composite abrasive article. The composite article is then removed from the mold and heated in order to produce the final article.

Various embodiments provide a method of using the composite abrasive article formed from a first portion having a first color and a second portion of the article having a second color different than the first color. The method includes contacting a surface and the composite abrasive article. The method further includes moving the article with respect to the surface.

Various embodiments of the composite abrasive article and methods of using the same have certain advantages, at least some of which are unexpected. According to some embodiments, the multicolor appearance of the composite abrasive article can allow a consumer or user to quickly identify the contents or intended use of the composite abrasive article. According to some embodiments, different colors present in the article can be used to indicate a company logo within or throughout the article. According to some embodiments, the contrast in colors between pluralities of particles can help to show the user or consumer the distribution of the particles in the article. In some embodiments, the different colors of the article may also serve as a mistake-proofing feature in that a user can associate certain colors or patterns with a specific article. Additionally, in some embodiments, the different colors may aid users and consumers in identifying the brand of the abrasive article. According to various embodiments, the different colors present in the article can also be used to indicate whether the article is approaching the end of its useful life. In some embodiments, the pluralities of particles may be arranged in specific patterns that produce a visual indication at a predetermined rotational speed of the article indicating that the article may be used for the desired application.

### BRIEF DESCRIPTION OF THE FIGURES

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a perspective view showing an embodiment of a composite abrasive article.

FIG. 2 is a sectional view of the composite abrasive article taken along line 2-2 of FIG. 1.

FIGS. 3A-3F depict various examples of shaped ceramic abrasive particles of the composite abrasive article.

FIG. 4 is a photograph showing wheels of Example 1.

FIG. 5 is a photograph showing additional wheels of Example 2.

FIG. 6 is a photograph showing additional wheels of Comparative Example A.

FIG. 7 is a photograph showing additional wheels of Comparative Example B.

FIG. 8 is a photograph showing a wheel of Comparative Example C.

FIG. 9 is a photograph showing a wheel of Comparative Example D.

FIG. 10 is a photograph showing a wheel of Example 3.

FIG. 11 is a photograph showing a wheel of Example 4.

### DETAILED DESCRIPTION OF THE DISCLOSURE

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting: information that is relevant to a section heading may occur within or outside of that particular section. All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.9997% or more, or 100%.

### Composite Abrasive Article

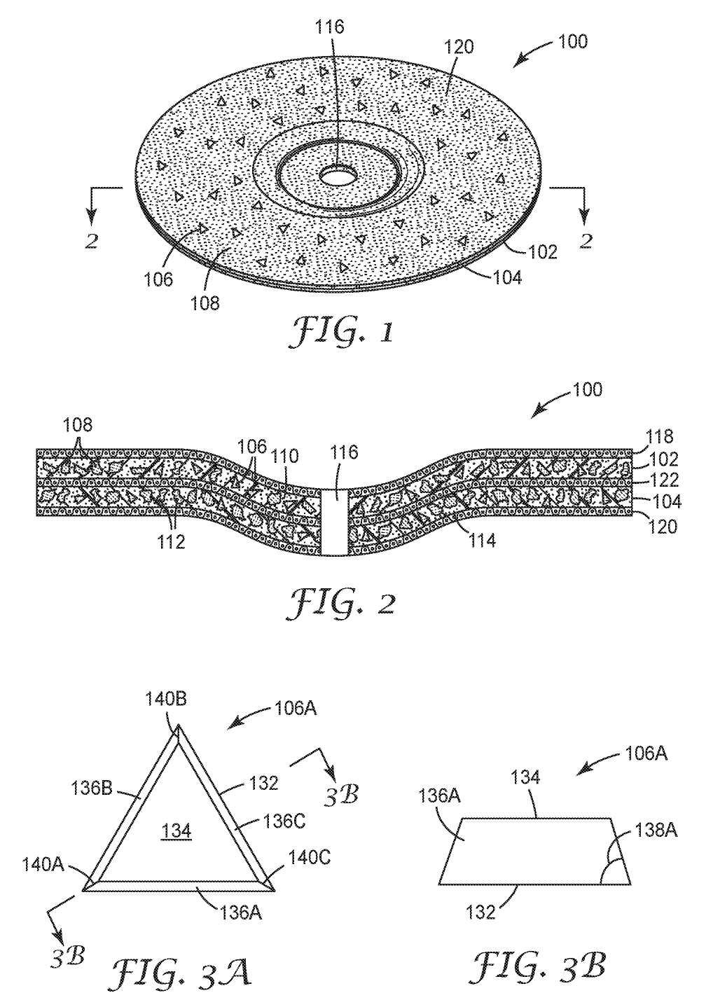

FIGS. 1 and 2 show an example of an abrasive article 100 according to one embodiment. Specifically FIG. 1 is a perspective view of composite abrasive article 100 and FIG. 2 is a sectional view of composite abrasive article 100 taken along line 2-2 of FIG. 1. FIGS. 1 and 2 show many of the same features and are discussed concurrently. As depicted, abrasive article 100 is a depressed center grinding wheel. In other examples, the abrasive article can be a cut-off wheel, cutting wheel, a cut-and-grind wheel, a depressed center cut-off wheel, a reel grinding wheel, a mounted point, a tool grinding wheel, a roll grinding wheel, a hot-pressed grinding wheel, a tool grinding wheel, a face grinding wheel, a grinding plug, a grinding cone, a rail grinding wheel, a cylindrical grinding wheel, and a double disk grinding wheel. The dimensions of the wheel can be any suitable size for example the diameter can range from 2 cm to about 2000 cm.

Article 100 includes first layer 102 and second layer 104. Each of layers 102 and 104 is formed from a number of different components. For example, first layer 102 is formed from shaped ceramic abrasive particles 106 and optional diluent smaller sized shaped ceramic abrasive particles or crushed abrasive particles 108, which are retained in first organic binder 110. Second abrasive layer 104 defines a back surface and is bonded to first layer 102. Second layer 104 includes secondary crushed abrasive particles 112 retained in second organic binder 114. Second organic binder 114 may be the same as, or different than, first organic binder 110. Composite abrasive article 100 includes central aperture 116 that extends from first layer 102 through second layer 104. Central aperture 116 can be used, for example, for attachment to a power driven tool. First layer 102 optionally further includes primary reinforcing material 118 adjacent to the front of first layer 102. Second layer 104 optionally further includes secondary reinforcing material 120 adjacent to the back of second layer 104. Optional reinforcing material 122 is sandwiched between, and/or is disposed at the junction of first layer 102 and second layer 104. In some embodiments, first layer 102 and second layer 104 contact each other, while in other embodiments they are bonded to one another through one or more additional elements (e.g., a layer of a third organic binder optionally including a reinforcing material).

As shown, composite abrasive article 100 is formed to have at least two different colors. That is, a first portion of article 100 has a first color and a second portion of article 100 can have a second color that is different from the first color. The first and second color can be white, red, orange, yellow, green, blue, indigo, violet, black, or any shade thereof. In further examples, a third portion of composite abrasive article 100 can have a third color that is different than at least one of the first and second colors. Composite abrasive article 100 can further include a fourth portion having a fourth color different than at least one of the first, second, and third colors. The third color and the fourth color can be white, red, orange, yellow, green, blue, indigo, violet, black or any shade thereof. Composite abrasive article 100 can include as few as two portions and can include more than four portions in additional examples.

As used herein, the term “portion” refers to any discrete component or subcomponent of composite abrasive article 100. Each portion can be expressed to account for a certain weight percent of article 100. For example, at least one of the first portion, the second portion, the third portion, and the fourth portion can range from about 2 wt % to about 50 wt % of article 100, or from about 10 wt % to about 25 wt % of article 100, or less than, equal to, or greater than about 5 wt %, 10, 15, 20, 25, 30, 35, 40, or 45 wt % of article 100. Examples of components or subcomponents that each portion can include are first layer 102 and second layer 104 of article 100. Correspondingly, the third portion and fourth portion can refer to a third and fourth layer of article 100.

Additionally, each portion can include the particles of composite abrasive article 100. For example, the first portion can include a first plurality of particles of article 100 while the second portion can include a second plurality of particles of article 100. Correspondingly, the third portion can include a third plurality of particles of article 100 and the fourth portion can include a fourth plurality of particles of article 100. At least one of the first plurality of particles, the second plurality of particles, the third plurality of particles, and the fourth plurality of particles can include shaped abrasive particles, crushed abrasive particles, conventional particles (e.g., extruded or generally rod-shaped particles), filler particles, or glitter.

Each plurality of particles can differ in color while being the same type of particle. For example, the first plurality of particles can be red, the second plurality of particles can be yellow, the third plurality of particles can be white, and the fourth plurality of particles can be green. However, the shape of each particle can be the same. Referring back to FIG. 2, the total number of shaped ceramic abrasive particles 106 in first layer 102 can be divided into two or more portions, each having a different color, while having substantially the same shape. In other examples, each of at least one of the first plurality of particles, the second plurality of particles, the third plurality of particles, and the fourth plurality of particles can have a different shape than at least one of the other pluralities of particles. For example, the shape of the first plurality of particles may resemble a truncated regular triangular pyramid. The second plurality of particles can be any one of another type of shaped ceramic abrasive particle, a crushed ceramic abrasive particle having an irregular shape, a conventional ceramic abrasive particle, an irregularly shaped filler particle, a grinding aid particle, or an irregularly shaped glitter particle. In some examples, the shape of two or more pluralities of particles can be the same but the size of each particle may be different. For example, the first and second pluralities may resemble a truncated pyramid. However, the size of the first plurality of particles may be larger than those of the second plurality of particles. The size difference may be measured in terms of the dimensions of the particles.

Many different color combinations are possible according to various embodiments of bonded abrasive article 100. For example, if bonded abrasive article 100 includes a first portion and a second portion having first and second colors, different color combinations can include: black and red; red and yellow; black and orange; red and orange; black and green; red, and green; yellow and green; black and gray; green and gray; or red and gray. If bonded abrasive article 100 further includes a third portion having a third color different than the first and second colors, different color combinations can include: black, red and yellow; black, red, and orange; black, red, and green; red, yellow, and green; and black, red, and gray. If bonded abrasive article 100 further includes a fourth portion having a fourth color different than the first, second, and third colors, different color combinations can include black, red, yellow, and orange; black, red, yellow, and gray; black, red, yellow, and green; black, red, orange, and gray; black, red, orange, and green; red, yellow, orange, and gray; red, yellow, orange, and green; and yellow, orange, gray, and green.

In various additional embodiments of bonded abrasive wheel 100, at least first layer 102 and second layer 104 may have different colors and a third layer may have the same color or a different color as compared to one of first layer 102 and second layer 104.

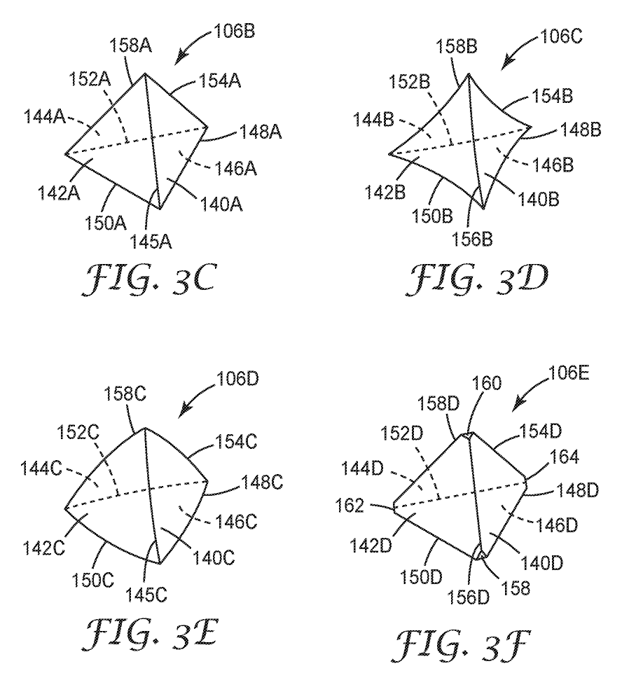

FIGS. 3A-3F depict various examples of shaped ceramic abrasive particles 106 that can be formed to have a predetermined color. As shown in FIGS. 3A and 3B shaped ceramic abrasive particle 106A includes a truncated regular triangular pyramid bounded by a triangular base 132, a triangular top 134, and plurality of sloping sides 136A, 136B, 136C connecting triangular base 132 (shown as equilateral) and triangular top 134. Slope angle 138A is the dihedral angle formed by the intersection of side 136A with triangular base 132. Similarly, slope angles 138B and 138C (both not shown) correspond to the dihedral angles formed by the respective intersections of sides 136B and 136C with triangular base 132. In the case of shaped ceramic abrasive particle 106, all of the slope angles have equal value. In some embodiments, side edges 140A, 140B, and 140C have an average radius of curvature of less than 50 micrometers, although this is not a requirement.

In the embodiment shown in FIGS. 3A and 3B, sides 136A, 136B, and 136C have equal dimensions and form dihedral angles with the triangular base 132 of about 82 degrees (corresponding to a slope angle of 82 degrees). However, it will be recognized that other dihedral angles (including 90 degrees) may also be used. For example, the dihedral angle between the base and each of the sides may independently range from 45 to 90 degrees (for example, from 70 to 90 degrees, or from 75 to 85 degrees).

As shown in FIG. 3C, ceramic shaped abrasive particle 106B may be shaped as a regular tetrahedron as shown in FIG. 3C. Accordingly, ceramic shaped abrasive particle 106B has four congruent planar major sides 140A, 142A, 144A, and 146A joined by six common edges 148A, 150A, 152A, 154A, 156A and 158A.

In other embodiments, ceramic shaped abrasive particles 106 may be shaped as shown in FIG. 3D. As shown, ceramic shaped abrasive particle 106C has four concave major sides 140B, 142B, 144B, and 146B joined by six common edges 148B, 150B, 152B, 154B, 156B, and 158B. In other embodiments, ceramic shaped abrasive particles 106 may be shaped as shown in FIG. 3E. Accordingly, ceramic shaped abrasive particle 106D has four convex major sides 140C, 142C, 144C, and 146C joined by six common edges 148C, 150C, 152C, 154C, 156C, and 158C.

In other embodiments, ceramic shaped abrasive particles 106 may be shaped as a truncated tetrahedron as shown in FIG. 3F. Accordingly, ceramic shaped abrasive particle 106E has four planar major sides 140D, 142D, 144D, and 146D joined by six common edges 148D, 150D, 152D, 154D, 156D and 158D of substantially the same length. Particle 106E further includes vertexes 158, 160, 162, and 164.

The shaped ceramic abrasive particles 106A-106E described herein can be made using tools (e.g., molds) cut using diamond tooling, which provides higher feature definition than other fabrication alternatives such as, for example, stamping or punching. The cavities in the tool surface can have planar faces that meet along sharp edges and form the sides and top of a truncated pyramid. The resultant shaped ceramic abrasive particles have a respective nominal average shape that corresponds to the shape of cavities (e.g., truncated pyramids) in the tool surface; however, variations (e.g., random variations) from the nominal average shape may occur during manufacture, and shaped ceramic abrasive particles exhibiting such variations are included within the definition of shaped ceramic abrasive particles as used herein.

As used herein in referring to the size of shaped ceramic abrasive particles, the term “length” refers to the maximum dimension of a shaped abrasive particle. The term “width” refers to the maximum dimension of the shaped abrasive particle that is perpendicular to the length. The terms “thickness” or “height” refer to the dimension of the shaped abrasive particle that is perpendicular to the length and width.

The shaped ceramic abrasive particles can be selected to have a length in a range from 0.001 mm to 26 mm or from 0.1 mm to 10 mm, or from 0.5 mm to 5 mm, although other lengths may also be used. In some embodiments, the length may be expressed as a fraction of the thickness of composite abrasive article 100 in which it is contained. For example, the shaped abrasive particle may have a length greater than half the thickness of the composite abrasive article 100. In some embodiments, the length may be greater than the thickness of the composite abrasive article 100.

The shaped ceramic abrasive particles can be selected to have a width in a range of from 0.001 mm to 26 mm, or from 0.1 mm to 10 mm, or from 0.5 mm to 5 mm, although other lengths may also be used. The shaped ceramic abrasive particles can be selected to have a thickness in a range of from 0.005 mm to 1.6 mm, or from 0.2 to 1.2 mm. In some embodiments, the shaped ceramic abrasive particles may have an aspect ratio (length to thickness) of at least 2, 3, 4, 5, 6, or more.

Surface coatings on the shaped ceramic abrasive particles may be used to improve the adhesion between the shaped ceramic abrasive particles and a binder material in abrasive articles, or can be used to aid in electrostatic deposition of the shaped ceramic abrasive particles. In one embodiment, surface coatings as described in U.S. Pat. No. 5,352,254 (Celikkaya) in an amount of 0.1 to 2 percent surface coating to shaped abrasive particle weight may be used. Such surface coatings are described in U.S. Pat. No. 5,213,591 (Celikkaya et al.); U.S. Pat. No. 5,011,508 (Wald et al.); U.S. Pat. No. 1,910,444 (Nicholson); U.S. Pat. No. 3,041,156 (Rowse et al.); U.S. Pat. No. 5,009,675 (Kunz et al.); U.S. Pat. No. 5,085,671 (Martin et al.); U.S. Pat. No. 4,997,461 (Markhoff-Matheny et al.); and U.S. Pat. No. 5,042,991 (Kunz et al.). Additionally, the surface coating may prevent the shaped abrasive particle from capping. Capping is the term to describe the phenomenon where metal particles from the workpiece being abraded become welded to the tops of the shaped ceramic abrasive particles. Surface coatings to perform the above functions are known to those of skill in the art.

According to the present disclosure, composite abrasive article 100 may further include crushed abrasive particles (e.g., abrasive particles not resulting from breakage of the shaped ceramic abrasive particles) corresponding to an abrasive industry specified nominal grade or combination of nominal grades. If present, the crushed abrasive particles can be of finer size grade, or grades (e.g., if a plurality of size grades are used), than the shaped ceramic abrasive particles, although this is not a requirement. Crushed abrasive particles can also be designed to have a predetermined color.

Composite abrasive article 100 may further include crushed abrasive particles corresponding to an abrasive industry specified nominal grade or combination of nominal grades in first layer 102. The crushed abrasive particles can be of finer size grade, or grades (e.g., if a plurality of size grades are used), than the crushed abrasive particles in second layer 104, although this is not a requirement. Crushed abrasive particles can also be designed to have a predetermined color.

Examples of suitable crushed abrasive particles include, for example, crushed particles of fused aluminum oxide, heat treated aluminum oxide, white fused aluminum oxide, ceramic aluminum oxide materials such as those commercially available under the trade designation 3M CERAMIC ABRASIVE GRAIN from 3M Company of St. Paul, Minn., black silicon carbide, green silicon carbide, titanium diboride, boron carbide, tungsten carbide, titanium carbide, diamond, cubic boron nitride, garnet, fused alumina zirconia, sol-gel derived abrasive particles, iron oxide, chromia, ceria, zirconia, titania, silicates, tin oxide, silica (such as quartz, glass beads, glass bubbles and glass fibers) silicates (such as talc, clays (e.g., montmorillonite), feldspar, mica, calcium silicate, calcium metasilicate, sodium aluminosilicate, sodium silicate), flint, and emery. Examples of sol-gel derived abrasive particles can be found in U.S. Pat. No. 4,314,827 (Leitheiser et al.), U.S. Pat. No. 4,623,364 (Cottringer et al.); U.S. Pat. No. 4,744,802 (Schwabel), U.S. Pat. No. 4,770,671 (Monroe et al.); and U.S. Pat. No. 4,881,951 (Monroe et al.).

Abrasive particles used in composite abrasive article 100 of the present disclosure, whether crushed abrasive particles or shaped ceramic abrasive particles, may be independently sized according to an abrasives industry recognized specified nominal grade. Exemplary abrasive industry recognized grading standards include those promulgated by ANSI (American National Standards Institute), FEPA (Federation of European Producers of Abrasives), and JIS (Japanese Industrial Standard). Such industry accepted grading standards include, for example: ANSI 4, ANSI 6, ANSI 8, ANSI 16, ANSI 24, ANSI 30, ANSI 36, ANSI 40, ANSI 50, ANSI 60, ANSI 80, ANSI 100, ANSI 120, ANSI 150, ANSI 180, ANSI 220, ANSI 240, ANSI 280, ANSI 320, ANSI 360, ANSI 400, and ANSI 600; FEPA P8, FEPA P12, FEPA P16, FEPA P24, FEPA P30, FEPA P36, FEPA P40, FEPA P50, FEPA P60, FEPA P80, FEPA P100, FEPA P120, FEPA P150, FEPA P180, FEPA P220, FEPA P320, FEPA P400, FEPA P500, FEPA P600, FEPA P800, FEPA P1000, FEPA P1200; FEPA F8, FEPA F12, FEPA F16, and FEPA F24; and JIS 8, JIS 12, JIS 16, JIS 24, JIS 36, JIS 46, JIS 54, JIS 60, JIS 80, JIS 100, JIS 150, JIS 180, JIS 220, JIS 240, JIS 280, JIS 320, JIS 360, JIS 400, JIS 400, JIS 600, JIS 800, JIS 1000, JIS 1500, JIS 2500, JIS 4000, JIS 6000, JIS 8000, and JIS 10,000. More commonly, crushed aluminum oxide particles and non-seeded sol-gel derived alumina-based abrasive particles are independently sized to ANSI 60 and 80, or FEPA F36, F46, F54 and F60 or FEPA P60 and P80 grading standards.

Alternatively, the abrasive particles (e.g., crushed abrasive particles and/or shaped ceramic abrasive particles) can be graded to a nominal screened grade using U.S.A. Standard Test Sieves conforming to ASTM E-11“Standard Specification for Wire Cloth and Sieves for Testing Purposes”. ASTM E-11 prescribes the requirements for the design and construction of testing sieves using a medium of woven wire cloth mounted in a frame for the classification of materials according to a designated particle size. A designation may be represented as −18+20 meaning that the shaped ceramic abrasive particles pass through a test sieve meeting ASTM E-11 specifications for the number 18 sieve and are retained on a test sieve meeting ASTM E-11 specifications for the number 20 sieve. In one embodiment, the shaped ceramic abrasive particles have a particle size such that most of the particles pass through an 18 mesh test sieve and can be retained on a 20, 25, 30, 35, 40, 45, or 50 mesh test sieve. In various embodiments, the shaped ceramic abrasive particles can have a nominal screened grade of: −18+20, −201+25, −25+30, −30+35, −35+40, 5−40+45, −45+50, −50+60, −60+70, −70/+80, −80+100, −100+120, −120+140, −140+170, −170+200, −200+230, −230+270, −270+325, −325+400, −400+450, −450+500, or −500+635. Alternatively, a custom mesh size could be used such as −90+100.

Particles having different colors (e.g., shaped ceramic abrasive particles, crushed abrasive particles, conventional abrasive particles, filler particles, or grinding aids) may, for example, be homogenously or heterogeneously distributed throughout first layer 102 and/or second layer 104 of abrasive article 100. For example, abrasive particles may be concentrated toward the middle (e.g., located away from outer surfaces of), or only adjacent the outer edge, e.g., the periphery, of abrasive article 100. A depressed-center portion may contain a lesser amount of abrasive particles. The abrasive particles in first layer 102 can be homogenously distributed among each other, because the manufacture of the wheels is easier, and the cutting effect is optimized when the two types of abrasive particles are closely positioned to each other. Similarly, the abrasive particles in the second layer 104 can be homogenously distributed among each other. The homogenous distribution, along with subsequent treating described herein, can give composite abrasive article 100 a speckled or marble-like appearance. Alternatively, different portions can be heterogeneously distributed throughout either layer. This can cause article 100 to have distinct predetermined patterns. For instance, abrasive particles of a first color can be arranged in such a manner that when the article rotates at a predetermined speed a distinct pattern, shape, letter, word, or phrase can be observed by a user.

The abrasive particles may be treated with a coupling agent (e.g., an organosilane coupling agent) to enhance adhesion of the abrasive particles to the binder. The abrasive particles may be treated before combining them with the binder material or they may be surface treated in situ by including a coupling agent to the binder material.

Composite abrasive article 100 can be formed in many different ways. In some embodiments, alpha alumina based shaped ceramic abrasive particles of article 100 can be made according to a multistep process. Briefly, the method includes the steps of making either a seeded or non-seeded sol-gel alpha alumina precursor dispersion that can be converted into alpha alumina; filling one or more mold cavities having the desired outer shape of the shaped abrasive particle with the sol-gel, drying the sol-gel to form precursor shaped ceramic abrasive particles; removing the precursor shaped ceramic abrasive particles from the mold cavities; calcining the precursor shaped ceramic abrasive particles to form calcined, precursor shaped ceramic abrasive particles, and then sintering the calcined, precursor shaped ceramic abrasive particles to form shaped ceramic abrasive particles. The process will now be described in greater detail.

The method includes a step involving providing either a seeded or non-seeded dispersion of an alpha alumina precursor that can be converted into alpha alumina. The alpha alumina precursor dispersion often include a liquid that is a volatile component. In one embodiment, the volatile component is water. The dispersion should include a sufficient amount of liquid for the viscosity of the dispersion to be sufficiently low to enable filling mold cavities and replicating the mold surfaces, but not so much liquid as to cause subsequent removal of the liquid from the mold cavity to be prohibitively expensive. In one embodiment, the alpha alumina precursor dispersion includes from 2 percent to 90 percent by weight of the particles that can be converted into alpha alumina, such as particles of aluminum oxide monohydrate (boehmite), and at least 10 percent by weight, or from 50 percent to 70 percent, or 50 percent to 60 percent, by weight of the volatile component such as water. Conversely, the alpha alumina precursor dispersion in some embodiments contains from 30 percent to 50 percent, or 40 percent to 50 percent, by weight solids.

Aluminum oxide hydrates other than boehmite can also be used. Boehmite can be prepared by known techniques or can be obtained commercially. Examples of commercially available boehmite include products having the trade designations “DISPERAL,” and “DISPAL,” both available from Sasol North America, Inc., Houston, Tex., or “HiQ-40” available from BASF Corporation, Florham Park, N.J. These aluminum oxide monohydrates are relatively pure; that is, they include relatively little, if any, hydrate phases other than monohydrates, and have a high surface area.

The physical properties of the resulting shaped ceramic abrasive particles will generally depend upon the type of material used in the alpha alumina precursor dispersion. In one embodiment, the alpha alumina precursor dispersion is in a gel state. As used herein, a “gel” is a three dimensional network of solids dispersed in a liquid.

The alpha alumina precursor dispersion may contain a modifying additive or precursor of a modifying additive. The modifying additive can function to enhance some desirable property of the abrasive particles or increase the effectiveness of the subsequent sintering step. Modifying additives or precursors of modifying additives can be in the form of soluble salts and water soluble salts. They can include a metal-containing compound and can be a precursor of oxide of magnesium, zinc, iron, silicon, cobalt, nickel, zirconium, hafnium, chromium, yttrium, praseodymium, samarium, ytterbium, neodymium, lanthanum, gadolinium, cerium, dysprosium, erbium, titanium, and mixtures thereof. The particular concentrations of these additives that can be present in the alpha alumina precursor dispersion can be varied based on skill in the art. The introduction of a modifying additive or precursor of a modifying additive can cause the alpha alumina precursor dispersion to gel. The alpha alumina precursor dispersion can also be induced to gel by application of heat over a period of time. The alpha alumina precursor dispersion can also contain a nucleating agent (seeding) to enhance the transformation of hydrated or calcined aluminum oxide to alpha alumina. Nucleating agents suitable for this disclosure include fine particles of alpha alumina, alpha ferric oxide or its precursor, titanium oxides and titanates, chrome oxides, or any other material that will nucleate the transformation. The amount of nucleating agent, if used, should be sufficient to effect the transformation of alpha alumina. Nucleating such alpha alumina precursor dispersions is disclosed in U.S. Pat. No. 4,744,802 (Schwabel).

A peptizing agent can be added to the alpha alumina precursor dispersion to produce a more stable hydrosol or colloidal alpha alumina precursor dispersion. Suitable peptizing agents are monoprotic acids or acid compounds such as acetic acid, hydrochloric acid, formic acid, and nitric acid. Multiprotic acids can also be used but they can rapidly gel the alpha alumina precursor dispersion, making it difficult to handle or to introduce additional components thereto. Some commercial sources of boehmite contain an acid titer (such as absorbed formic or nitric acid) that will assist in forming a stable alpha alumina precursor dispersion. The alpha alumina precursor dispersion can be formed by any suitable means, such as, for example, by simply mixing aluminum oxide monohydrate with water containing a peptizing agent or by forming an aluminum oxide monohydrate slurry to which the peptizing agent is added.

Defoamers or other suitable chemicals can be added to reduce the tendency to form bubbles or entrain air while mixing. Additional chemicals such as wetting agents, alcohols, or coupling agents can be added if desired. The alpha alumina abrasive particles may contain silica and iron oxide as disclosed in U.S. Pat. No. 5,645,619 (Erickson et al.). The alpha alumina abrasive particles may contain zirconia as disclosed in U.S. Pat. No. 5,551,963 (Larmie). Alternatively, the alpha alumina abrasive particles can have a microstructure or additives as disclosed in U.S. Pat. No. 6,277,161 (Castro).

The process includes a step involving providing a mold having at least one mold cavity, and preferably a plurality of cavities. The mold can have a generally planar bottom surface and a plurality of mold cavities. The plurality of cavities can be formed in a production tool. The production tool can be a belt, a sheet, a continuous web, a coating roll such as a rotogravure roll, a sleeve mounted on a coating roll, or die. In one embodiment, the production tool includes polymeric material. Examples of suitable polymeric materials include thermoplastics such as polyesters, polycarbonates, poly(ether sulfone), poly(methyl methacrylate), polyurethanes, polyvinylchloride, polyolefin, polystyrene, polypropylene, polyethylene or combinations thereof, or thermosetting materials. In one embodiment, the entire tooling is made from a polymeric or thermoplastic material. In another embodiment, the surfaces of the tooling in contact with the sol-gel while drying, such as the surfaces of the plurality of cavities, includes polymeric or thermoplastic materials, and other portions of the tooling can be made from other materials. A suitable polymeric coating may be applied to a metal tooling to change its surface tension properties by way of example.

A polymeric or thermoplastic tool can be replicated off a metal master tool. The master tool will have the inverse pattern desired for the production tool. The master tool can be made in the same manner as the production tool. In one embodiment, the master tool is made out of metal, e.g., nickel, and is diamond turned. The polymeric sheet material can be heated along with the master tool such that the polymeric material is embossed with the master tool pattern by pressing the two together. A polymeric or thermoplastic material can also be extruded or cast onto the master tool and then pressed. The thermoplastic material is cooled to solidify and produce the production tool. If a thermoplastic production tool is utilized, then care should be taken not to generate excessive heat that may distort the thermoplastic production tool, thereby limiting its life. More information concerning the design and fabrication of production tooling or master tools can be found in U.S. Pat. No. 5,152,917 (Pieper et al.); U.S. Pat. No. 5,435,816 (Spurgeon et al.); U.S. Pat. No. 5,672,097 (Hoopman et al.); U.S. Pat. No. 5,946,991 (Hoopman et al.); U.S. Pat. No. 5,975,987 (Hoopman et al.); and U.S. Pat. No. 6,129,540 (Hoopman et al.).

Access to cavities can be from an opening in the top surface or bottom surface of the mold. In some instances, the cavities can extend for the entire thickness of the mold. Alternatively, the cavities can extend only for a portion of the thickness of the mold. In one embodiment, the top surface is substantially parallel to bottom surface of the mold with the cavities having a substantially uniform depth. At least one side of the mold, that is, the side in which the cavities are formed, can remain exposed to the surrounding atmosphere during the step in which the volatile component is removed.

The cavities have a specified three-dimensional shape to make the shaped ceramic abrasive particles. The depth dimension is equal to the perpendicular distance from the top surface to the lowermost point on the bottom surface. The depth of a given cavity can be uniform or can vary along its length and/or width. The cavities of a given mold can be of the same shape or of different shapes.

The process includes a step involving filling the cavities in the mold with the alpha alumina precursor dispersion (e.g., by a conventional technique). In some embodiments, a knife roll coater or vacuum slot die coater can be used. A mold release can be used to aid in removing the particles from the mold if desired. Suitable mold release agents can include oils such as peanut oil or mineral oil, fish oil, silicones, polytetrafluoroethylene, zinc stearate, and graphite. In general, mold release agent such as peanut oil, in a liquid, such as water or alcohol, is applied to the surfaces of the production tooling in contact with the sol-gel such that between about 0.1 mg/in² (0.02 mg/cm²) to about 3.0 mg/in² 0.46 mg/cm²), or between about 0.1 mg/in² (0.02 mg/cm²) to about 5.0 mg/in² (0.78 mg/cm²) of the mold release agent is present per unit area of the mold when a mold release is desired. In some embodiments, the top surface of the mold is coated with the alpha alumina precursor dispersion. The alpha alumina precursor dispersion can be pumped onto the top surface.

Next, a scraper or leveler bar can be used to force the alpha alumina precursor dispersion fully into the cavity of the mold. The remaining portion of the alpha alumina precursor dispersion that does not enter the cavity can be removed from the top surface of the mold and recycled. In some embodiments, a small portion of the alpha alumina precursor dispersion can remain on the top surface and in other embodiments the top surface is substantially free of the dispersion. The pressure applied by the scraper or leveler bar can be less than 100 psi (0.7 MPa), less than 50 psi (0.3 MPa), or even less than 10 psi (69 kPa). In some embodiments, no exposed surface of the alpha alumina precursor dispersion extends substantially beyond the top surface to ensure uniformity in thickness of the resulting shaped ceramic abrasive particles.

The process includes a step involving removing the volatile component to dry the dispersion. Desirably, the volatile component is removed by fast evaporation rates. In some embodiments, removal of the volatile component by evaporation occurs at temperatures above the boiling point of the volatile component. An upper limit to the drying temperature often depends on the material from which the mold is made. For polypropylene tooling the temperature should be less than the melting point of the plastic. In one embodiment, for a water dispersion of between about 40 to 50 percent solids and a polypropylene mold, the drying temperatures can be between about 90° C. to about 165° C., or between about 105° C. to about 150° C., or between about 105° C. to about 120° C. Higher temperatures can lead to improved production speeds but can also lead to degradation of the polypropylene tooling thereby limiting its useful life as a mold.

The process includes a step involving removing resultant precursor shaped ceramic abrasive particles from the mold cavities. The precursor shaped ceramic abrasive particles can be removed from the cavities by using the following processes alone or in combination on the mold: gravity, vibration, ultrasonic vibration, vacuum, or pressurized air to remove the particles from the mold cavities.

The precursor abrasive particles can be further dried outside of the mold. If the alpha alumina precursor dispersion is dried to the desired level in the mold, this additional drying step is not necessary. However, in some instances, it may be economical to employ this additional drying step to minimize the time that the alpha alumina precursor dispersion resides in the mold. The precursor shaped ceramic abrasive particles can be dried from 10 to 480 minutes, or from 120 to 400 minutes, at a temperature from 50° C. to 160° C., or at 120° C. to 150° C.

The process includes a step involving calcining the precursor shaped ceramic abrasive particles. During calcining, essentially all the volatile material is removed, and the various components that were present in the alpha alumina precursor dispersion are transformed into metal oxides. The precursor shaped ceramic abrasive particles are generally heated to a temperature from 400° C. to 800° C., and maintained within this temperature range until the free water and over 90 percent by weight of any bound volatile material are removed. In an optional step, it may be desired to introduce the modifying additive by an impregnation process. A water-soluble salt can be introduced by impregnation into the pores of the calcined, precursor shaped ceramic abrasive particles. Then the precursor shaped ceramic abrasive particles are pre-fired again. This option is further described in U.S. Pat. No. 5,164,348 (Wood).

The process includes a step involving sintering the calcined, precursor shaped ceramic abrasive particles to form alpha alumina particles. Prior to sintering, the calcined, precursor shaped ceramic abrasive particles are not completely densified and thus lack the desired hardness to be used as shaped ceramic abrasive particles. Sintering takes place by heating the calcined, precursor shaped ceramic abrasive particles to a temperature of from 1,000° C. to 1,650° C. and maintaining them within this temperature range until substantially all of the alpha alumina monohydrate (or equivalent) is converted to alpha alumina and the porosity is reduced to less than 15 percent by volume. The length of time to which the calcined, precursor shaped ceramic abrasive particles can be exposed to the sintering temperature to achieve this level of conversion depends upon various factors but usually from five seconds to 48 hours is suitable.

In another embodiment, the duration for the sintering step ranges from one minute to 90 minutes. After sintering, the shaped ceramic abrasive particles can have a Vickers hardness of 10 GPa, 16 GPa, 18 GPa, 20 GPa, or greater.

Other steps can be used to modify the described process such as, for example, rapidly heating the material from the calcining temperature to the sintering temperature and centrifuging the alpha alumina precursor dispersion to remove sludge and/or waste. Moreover, the process can be modified by combining two or more of the process steps if desired. Conventional process steps that can be used to modify the process of this disclosure are more fully described in U.S. Pat. No. 4,314,827 (Leitheiser). More information concerning methods to make shaped ceramic abrasive particles is disclosed in U.S. Publ. Patent Appln. No. 2009/0165394 A1 (Culler et al.).

In other examples the shaped abrasive particle can be formed through sintering as opposed to a sol-gel process. Briefly stated, a shaped precursor particle is sintered to form a ceramic shaped abrasive particle. The length of time that the particle is sintered can vary depending on the desired properties of the final shaped abrasive particle. This process is further described in U.S. Publ. Patent Appln. No. 2015/0267097 A1 (Rosenflanz et al.).

### Methods of Forming Abrasive Articles

Composite abrasive articles 100, according to the present disclosure, can be made according to any suitable method. In one suitable method, the non-seeded sol-gel derived alumina-based abrasive particles are coated with a coupling agent prior to mixing with the curable organic binder such as a phenolic resin. A first coloring element having a first color can then be mixed with the particles. The first coloring element can be glitter or a pigment. Suitable pigments include titanium dioxide (white), Blue 385 and Carmin 6B (FL1019), Sicotan Yellow K 2001, CS1450 Heucospere (green), Red Kroma RO-3097, and Black Monarch 120. The amount of coupling agent is generally selected such that it is present in an amount of 0.1 to 0.3 parts for every 50 to 84 parts of abrasive particles, although amounts outside this range may also be used. The liquid resin, as well as the curable organic binder and fillers and grinding aids are added to the mixture. The mixture is pressed into a mold (e.g., at an applied pressure ranging from 1.5 MPa to about 2.0 MPa.) The molded wheel is then cured by heating the wheel at suitable temperatures, for example, temperatures ranging from about 70° C. to about 200° C. The wheel is heated for a sufficient time to cure the resin. For example, suitable times can range from about 2 hours to about 40 hours. Curing can also be done in a stepwise fashion, for example, the wheel can be heated to a first temperature ranging from about 70° C. to about 95° C. for a time ranging from about 2 hours to about 40 hours. The wheel can then be heated at a second temperature ranging from about 100° C. to about 125° C. for a time ranging from about 2 hours to about 40 hours. The wheel can then be heated at a third temperature ranging from about 140° C. to about 200° C. for a time ranging from about 2 hours to about 10 hours. The wheels can be cured in the presence of air. Alternatively, to help preserve color, the wheel can be cured at a higher temperature (e.g., greater than 140° C.) under nitrogen where the concentration of oxygen is relatively low.

In additional embodiments, in which particular particles are designed to have a predetermined color, the process can be modified to include mixing a first plurality of particles (e.g., shaped abrasive particles) with a first coloring element and separately mixing a second plurality of particles with a second coloring element. Alternatively, one of the first and second pluralities of particles may be mixed without being mixed with a coloring element. That is particle's natural color can be retained and used in conjunction with particles having another color to create the multi-colored appearance of article 100.

For example, a first plurality of particles can be mixed with an organic binder such as liquid phenolic resin as well as a powder phenolic resin and a pigment such as a yellow pigment. Separately, a second plurality of particles can be mixed with an organic binder such as liquid phenolic resin as well as a powder phenolic resin and a different pigment such as a green pigment. Each mixture is mixed separately and then combined. This procedure can be applied similarly to a third or fourth portion of particles that are incorporated into abrasive article 100. In additional embodiments, a plurality of particles can be designed to have a golden color. This can be accomplished by mixing the plurality of particles with a binding solution of an aqueous sodium silicate mixture, and a surfactant with a metallic coloring element. An example of a metallic coloring element is Eldorado Gold Satin MGF-302, which gives the particles a golden color. The particles can then be incorporated into the wheel.

In some examples, a color of at least one of the first plurality of particles, second plurality of particles, third plurality of particles, and fourth plurality of particles remains substantially the same after the wheel is heated. In additional examples, a color of at least one of the first plurality of particles, second plurality of particles, third plurality of particles, and fourth plurality of particles is substantially changed after the wheel is heated.

Organic binders, as described herein, can be included in the first and second layers 102 and 104 in amounts of from 5 to 30 percent, more preferably 10 to 25, and even more preferably 15 to 24 percent by weight, based on the total weight of the respective first and second layers 102 and 104, however other amounts may also be used. The organic binder can be formed by at least partially curing a corresponding organic binder precursor.

Phenolic resin, as described herein, is an exemplary useful organic binder precursor, and may be used in powder form and/or liquid state. Organic binder precursors that can be cured (e.g., polymerized and/or crosslinked) to form useful organic binders include, for example, one or more phenolic resins (including novolac and/or resole phenolic resins), one or more epoxy resins, one or more urea-formaldehyde binders, one or more polyester resins, one or more polyimide resins, one or more rubbers, one or more polybenzimidazole resins, one or more shellacs, one or more acrylic monomers and/or oligomers, and combinations thereof. The organic binder precursor(s) may be combined with additional components such as, for example, curatives, hardeners, catalysts, initiators, colorants, antistatic agents, grinding aids, and lubricants.

Useful phenolic resins include novolac and resole phenolic resins. Novolac phenolic resins are characterized by being acid-catalyzed and having a ratio of formaldehyde to phenol of less than one, for example, between 0.5:1 and 0.8:1. Resole phenolic resins are characterized by being alkaline catalyzed and having a ratio of formaldehyde to phenol of greater than or equal to one, for example from 1:1 to 3:1. Novolac and resole phenolic resins may be chemically modified (e.g., by reaction with epoxy compounds), or they may be unmodified. Exemplary acidic catalysts suitable for curing phenolic resins include sulfuric, hydrochloric, phosphoric, oxalic, and p-toluenesulfonic acids. Alkaline catalysts suitable for curing phenolic resins include sodium hydroxide, barium hydroxide, potassium hydroxide, calcium hydroxide, organic amines, or sodium carbonate.

Phenolic resins are well-known and readily available from commercial sources. Examples of commercially available novolac resins include DUREZ 1364, a two-step, powdered phenolic resin (marketed by Durez Corporation, Addison, Tex., under the trade designation VARCUM (e.g., 29302), or HEXION AD5534 RESIN (marketed by Hexion Specialty Chemicals, Inc., Louisville, Ky.). Examples of commercially available resole phenolic resins useful in practice of the present disclosure include those marketed by Durez Corporation under the trade designation VARCUM (e.g., 29217, 29306, 29318, 29338, 29353); those marketed by Ashland Chemical Co., Bartow, Fla. under the trade designation AEROFENE (e.g., AEROFENE 295); and those marketed by Kangnam Chemical Company Ltd., Seoul, South Korea under the trade designation “PHENOLITE” (e.g., PHENOLITE TD-2207).

Composite abrasive wheels may be formed to one of many shapes, for example, the wheel may have a shallow or flat dish or saucer with curved or straight flaring sides, and may have either a straight or depressed center portion encircling and adjacent to the central aperture (e.g., as in a Type 27 depressed center grinding wheel). As used herein, the term “straight center” is meant to include composite abrasive wheels other than depressed-center or raised-hub abrasive wheels, and those having front and back surfaces that continue without any deviation or sharp bends to the central aperture.

Composite abrasive wheels, according to the present disclosure are useful, for example, as grinding wheels, including abrasives industry Type 27 (e.g., as in American National Standards Institute standard ANSI B7.1-2000 (2000) in section 1.4.14) depressed-center grinding wheels.

In use, a peripheral grinding edge of the front surface of a rotating composite abrasive wheel according to the present disclosure is secured to a rotating powered tool and brought into frictional contact with a surface of a workpiece and at least a portion of the surface is abraded. If used in such a manner, the abrasive performance of composite abrasive article 100 advantageously closely resembles the abrasive performance of a single layer construction wherein the shaped ceramic abrasive particles, and any optional diluent crushed abrasive particles, are distributed throughout the abrasive wheel.

Composite abrasive wheels, according to the present disclosure, can be used dry or wet. During wet grinding, the wheel is used in conjunction with water, oil-based lubricants, or water-based lubricants. Composite abrasive wheels according to the present disclosure may be particularly useful on various workpiece materials such as, for example, carbon steel sheet or bar stock and more exotic metals (e.g., stainless steel or titanium), or on softer more ferrous metals (e.g., mild steel, low alloy steels, or cast iron).

There are many reasons to use composite abrasive article 100 of the present disclosure including the following non-limiting reasons. The ability to color individual particles can allow a consumer or user to quickly identify the contents of composite abrasive article 100. For example, if shaped abrasive particles 106A are colored red and shaped abrasive particles 106B are colored green, then a user looking at composite abrasive article 100 will be able to quickly identify the particles used in article 100. This can help the user to quickly determine whether article 100 is suited for their particular needs. Specifically, if the consumer can see the shape of certain particles, they might be more likely to use the article after visually identifying the shape of each particle and deeming them to be suitable for their specific application.

Similarly, the contrast in colors between pluralities of particles can help to show the user or consumer the distribution of the particles in article 100. That is, in articles that have only one color, it is difficult for a user to determine whether the components of the article are uniformly or evenly distributed throughout the article. This is because the color of the particles blends into the other components. However, if the consumer or user can actually see the particle's distribution, they may feel more confident that article 100 is better suited for their needs, whether they desire a heterogeneous or homogenous distribution of particles.

The different colors of article 100 may also serve as a mistake proofing feature. For example, different color combinations can be associated with different grades or components of abrasive article 100 that can be used for different applications or materials such as grinding aluminum or used for masonry. Thus, if a consumer or user needs a particular grade of abrasive article 100 they may select the version displaying the colors associated with that particular grade.

Additionally the different colors may aid users and consumer in identifying the brand of abrasive article 100. That is, consumers and users may associate certain colors and patterns with the brand. Thus the user or consumer can more quickly differentiate the article from others based on a quick visual assessment of article 100, compared to other articles that do not display at least two different colors.

The different colors present in article 100 can also be used to indicate whether article 100 is approaching the end of its life. For example, first layer 102 can be adapted as an abrasive layer having a green color and second layer 104 can be adapted as a non-abrasive backing layer having a red color. During operation as the abrasive layer is taken away, more red color will be visible. Once the red reaches a predetermined level, the user may decide to use another abrasive article 100. In this manner the user will know that it is time to switch out article 100 based on a clear visual indication, rather than having to guess whether it is time to replace article 100 based on the perceived performance of article 100. Conversely, if each layer has a distribution of particles of different colors, the user or consumer can visually inspect article 100 to determine whether the abrasive particle content in article 100 is sufficient for their use.

In other examples, the pluralities of particles may be arranged in specific patterns that that produce a visual indication at a predetermined rotational speed of article 100. Once a user observes the indication they will know that article 100 is rotating at a speed that is acceptable for their particularly application.

### EXAMPLES

Unless otherwise noted, all parts, percentages, ratios, etc. in the Examples and the rest of the specification are by weight.

The abbreviations shown in Table 1 are used for materials in the Examples.

TABLE 1

| ABBRE- | |
|---|---|
| VIATION | DESCRIPTION |
| SAP1 | Shaped abrasive particles were prepared generally according |
| | to the disclosure of U. S. Patent Publication No. |
| | 2015/0267097 (Rosenflanz et al). The resulting shaped |
| | abrasive particles were about 1.4 mm (side length) × 0.35 mm |
| | (thickness), with a draft angle approximately 98 degrees. |
| AP1 | Grade 36 brown aluminum oxide abrasive particles, obtained |
| | from Washington Mills, Niagara Falls, New York. |
| PR1 | liquid phenolic resin, obtained under trade designation |
| | “PREFERE 825136G1” from Dynea Oy Corporation, |
| | Helsinki, Finland. |
| PR2 | phenolic resin powder (a solid phenolic resin), obtained under |
| | trade designation “VARCUM 29302” from Durez |
| | Corporation, Dallas, Texas. |
| CRY | Sodium hexafluoroaluminate, obtained under trade |
| | designation “CRYOLITE” from Freebee, Ullerslev, Denmark. |
| SCRIM1 | fiberglass mesh scrim, obtained under the trade designation |
| | “PS 660” from Swatycomet D.O.O., Maribor, Slovenia. |
| SCRIM2 | fiberglass mesh having the trade designation “STYLE 184” |
| | from Industrial Polymer and Chemicals, Inc. |

### Grinding Test

Abrasive wheels were tested by grinding a rectangular mild steel bar (0.25 inch (0.6 cm)×18 inches (45.7 cm)×3 inches (7.6 cm)) over a 0.25 inch (0.6 cm)×18 inches (45.7 cm) area of the surface while mounted on a 12000 resolution per minute air driven grinder that oscillated back and forth (one cycle=18 inches (45.7 cm) each way for a total of 36 inches (91 cm)) for ten one-minute cycles. The applied load was the grinder weight of 9 pounds (4.1 kg) and the abrasive wheel was held at an angle of 15 degrees relative to the surface (e.g., 0 degrees). The steel bar was weighed before and after each cycle, and the weight loss (e.g., cut) in grams was recorded. The steel bar was traversed 16 times from end to end per cycle. Total Cut was calculated as the total weight loss of the steel bar over 10 minutes test.

### Example 1

A “yellow” mixture was prepared as follows: 800 grams of SAP1 were combined with 60 grams of PR1 and mixed for 10 minutes by a paddle-type mixer (obtained as “CUISINART SM-70” from Conair Corporation, East Windsor, N.J., operated at speed 1). Then 8 grams of yellow pigment, obtained as “SICOTAN Yellow K 2001 FG” from BASF, Ludwigshafen, Germany, were added and mixed for 1 minute using the mixer before adding 140 grams of PR2 and 140 grams of CRY. The resulting mixture was mixed for another 10 minutes using the mixer.

A “green” mixture was prepared as follows: 800 grams of API were combined with 60 grams of PR1 and mixed for 10 minutes by the mixer before adding 8 grams of green pigment, obtained as “CS1450 HEUCOSPERE” from Heucotech Company, Fairless Hill, Pa. and mixing for additional 1 minute. Then 140 grams of PR2 and 140 grams of CRY were added and the resulting mixture was mixed for 10 minutes.

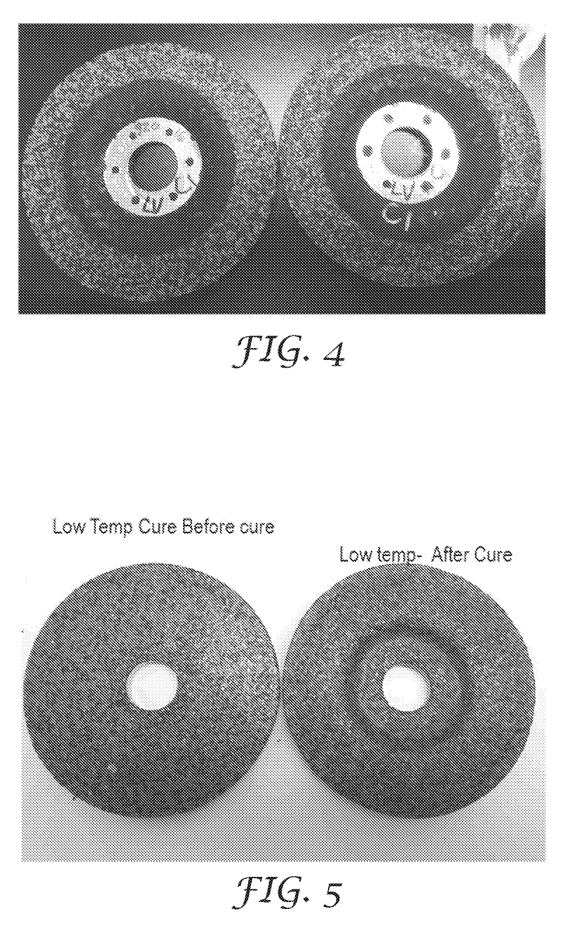

A Type 27 depressed-center composite grinding wheel was prepared as follows: A 4.5-inch (11.4 centimeters) diameter disc of SCRIM1 was placed into a 4.5-inch (11.4 centimeters) diameter cavity die. 75 grams of a mixture including 50 parts of “yellow” mixture and 50 parts of “green” mixture was spread out evenly. A second 4-inch (10.2 centimeters) diameter disc of SCRIM1 was placed on top of the mixture. Then additional 75 grams of a mixture including 60 parts of “yellow” mixture and 50 parts of “green” mixture was spread out evenly. A third 3-inch (7.4 centimeters) diameter disc of SCRIM1 was placed on top of the mixture. The filled cavity mold was then pressed at a pressure of 40 tons/38 square inches (14.5 MegaPascals). The resulting wheel with yellow/green marble-like appearance was removed from the cavity mold and placed on a spindle between depressed center aluminum plates to be pressed into a Type 27 depressed-center grinding wheel. The wheel was compressed at 5 ton/38 square inches (1.8 MegaPascals) to shape the disc. The colored bonded wheel was placed in an oven to cure for 3 hours at 90° C., ramp up to 120° C. for 2 hours and hold at 120° C. for 3 hours, ramp up to 150° C. for 3 hours, hold at 150° C. for 7 hours. Then the wheel was allowed to cool down naturally to approximately 23° C. A photo of the resulting grinding wheel is shown in FIG. 4.

### Example 2

A “red” mixture was prepared as follows: 800 grams of SAP1 were combined with 60 grams of PR1 and mixed for 10 minutes by a paddle-type mixer (obtained as “CUISINART SM-70” from Conair Corporation, East Windsor, N.J., operated at speed 1). Then 9 grams of red iron oxide pigment, obtained as “RED KROMA RO-309T” from Rockwood Pigments, Beltwville, Md., were added and mixed for 1 minute using the mixer before adding 140 grams of PR2 and 140 grams of CRY. The resulting mixture was mixed for another 10 minutes using the mixer.

A “black” mixture was prepared as follows: 800 grams of API were combined with 60 grams of PR1 and mixed for 10 minutes by the mixer before adding 9 grams of carbon black powder pigment, obtained as “Monarch 120” from Cabot, Boston, Mass., and mixing for additional 1 minute. Then 140 grams of PR2 and 140 grams of CRY were added and the resulting mixture was mixed for 10 minutes.

A Type 27 depressed-center composite grinding wheel was prepared as follows: A 4.5-inch (11.4 centimeters) diameter disc of SCRIM1 was placed into a 4.5-inch (11.4 centimeters) diameter cavity die. 75 grams of a mixture including 50 parts of “red” mixture and 50 parts of “black” mixture was spread out evenly. A second 4-inch (10.2 centimeters) diameter disc of SCRIM1 was placed on top of the mixture. Then additional 75 grams of a mixture including 50 parts of “red” mixture and 50 parts of “black” mixture was spread out evenly. A third 3-inch (7.4 centimeters) diameter disc of SCRIM1 was placed on top of the mixture. The filled cavity mold was then pressed at a pressure of 40 tons/38 square inches (14.5 MegaPascals). The resulting wheel with red/black marble-like appearance was removed from the cavity mold and placed on a spindle between depressed center aluminum plates to be pressed into a Type 27 depressed-center grinding wheel. The wheel was compressed at 5 ton/38 square inches (1.8 MegaPascals) to shape the disc. The colored bonded wheel was placed in an oven to cure for 3 hours at 90° C. ramp up to 120° C. for 2 hours and hold at 120° C. for 3 hours, ramp up to 150° C. for 3 hours, hold at 150° C. for 7 hours. Then the wheel was allowed to cool down naturally to approximately 23° C. A photo of the resulting grinding wheel is shown in FIG. 5.

### Comparative Example A

The procedure generally described in Example 1 was repeated, with the exception that the colored bonded wheel was cured in an oven with the temperature programmed as follows: 7 hours at 79° C., 3 hours at 107° C., 18 hours at 185° C. and a temperature ramp-down over 4 hours to 27° C.

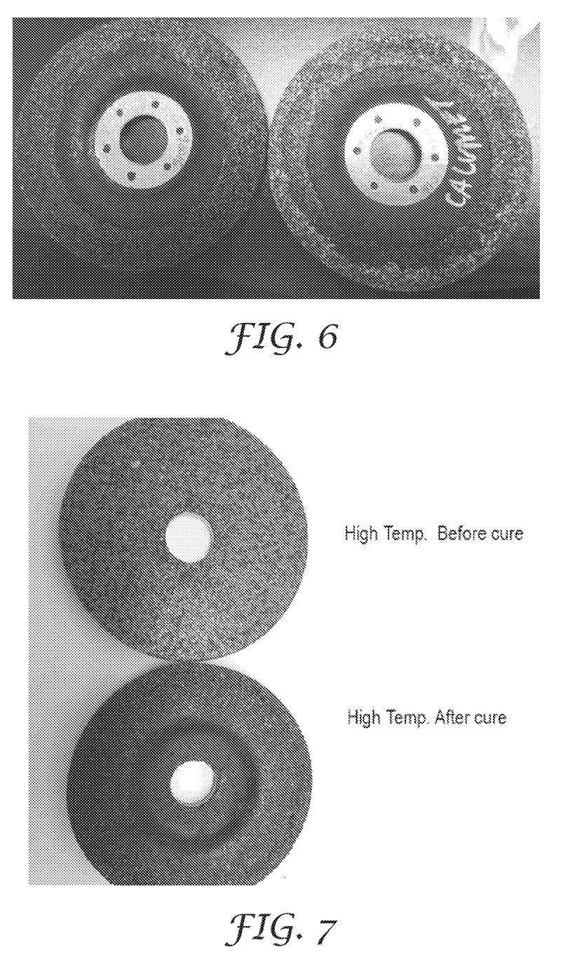

The dimensions of the final grinding wheel were 115 millimeter diameter, 7 millimeter thickness. The center hole was ⅞ inch (2.2 centimeters) in diameter. The outside wheel turn to black in the high temperature cure condition. A photo of the resulting grinding wheel is shown in FIG. 6.

### Comparative Example B

The procedure generally described in Example 2 was repeated, with the exception that the colored bonded wheel was cured in an oven with the temperature programmed as follows: 7 hours at 79° C., 3 hours at 107° C., 18 hours at 185° C., and a temperature ramp-down over 4 hours to 27° C.

The dimensions of the final grinding wheel were 115 millimeter diameter×7 millimeter thickness. The center hole was ⅞ inch (2.2 centimeters) in diameter. The outside wheel turn to black in the high temperature cure condition. A photo of the resulting grinding wheel is shown in FIG. 7.

### Comparative Example C

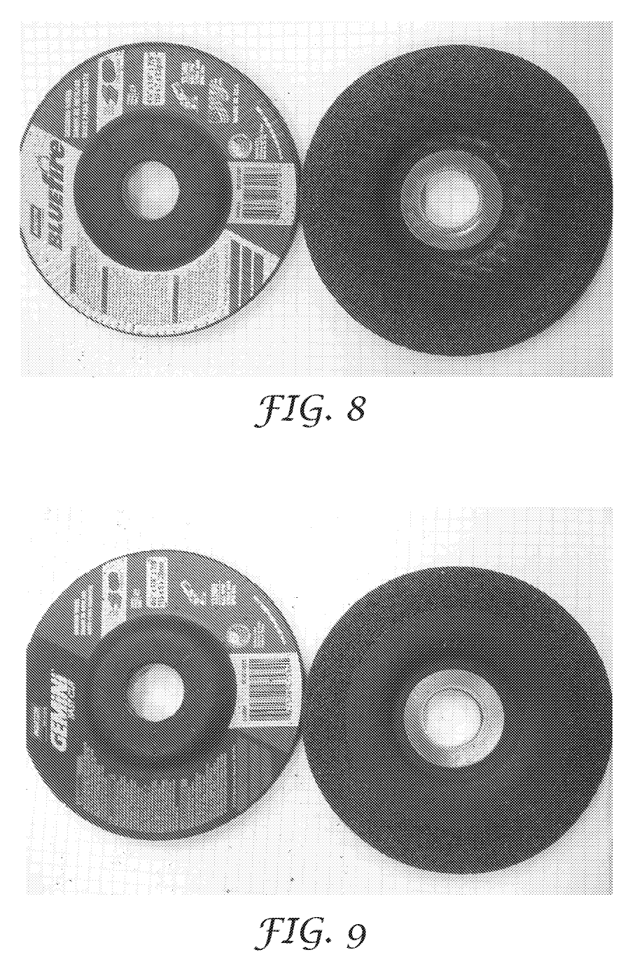

Abrasive wheel obtained as “BLUEFIRE DEPRESSED CENTER WHEELS—4½ INCH” (Type 27, shown in FIG. 8) from Saint Gobain S.A., Courbevoie, France.

### Comparative Example D

Abrasive wheel obtained as “GEMINI FAST CUT—4½ INCH” (Type 27, shown in FIG. 9) from Saint Gobain S.A., Courbevoie, France.

### Example 3

Preparation of golden color coated abrasive particles was carried out as follows. SAP1 (700 grams) was placed in a one quart plastic container. To the container 7 grams of a solution including 66.45 parts of sodium silicate (obtained as “B-W 50” from PQ Corporation, Valley Forge, Pa.), 33.22 parts of water and 0.33 parts of anionic surfactant (obtained as “DOWFAX 2A1” from Dow Chemical Corporation, Midland, Mich.) was added. The container was then capped and shaken for 1 minute. 0.1 gram of golden powder obtained as “ELDORADO GOLD SATIN MGF-302” from Impact Colors, Newark, Del., was added into the container, after which the container was capped and shaken for 1-2 minutes. The resulting mixture in the container was dispensed onto a pan. The pan was then placed in an oven to cure at 93.3° C. for 30 minutes, then ramped to 176.7° C. for 90 minutes.

A mixture was prepared by combining 200 grams of SAP1 200 grams of API with 30 grams of PR1. To the mixture, 2.8 grams of green pigment (obtained as “CS1450 HEUCOSPERE” from Heucotech Company, Fairless Hill, Pa.), 70 grams), 70 grams of PR2 and 70 grams of CRY were added and the resulting mixture was mixed for 10 minutes using the paddle-type mixer described in Example 1.

A Type 27 depressed-center composite grinding wheel was prepared as follows. A 4.5-inch (11.4 centimeters) diameter disc of SCRIM1 was placed into a 4.5-inch (11.4 centimeters) diameter cavity die. 75 grams of the mixture prepared as above was spread out evenly. A second 4-inch (10.2 centimeters) diameter disc of SCRIM1 was placed on top of the mixture. Then 67.5 grams of the mixture mixed with 7.5 grams of the golden coated abrasive particles was spread out evenly. A third 3-inch (7.4 centimeters) diameter disc of SCRIM1 was placed on top of the mixture. The filled cavity mold was then pressed at a pressure of 40 tons/38 square inches (14.5 MegaPascals). The resulting wheel was removed from the cavity mold and placed on a spindle between depressed center aluminum plates to be pressed into a Type 27 depressed-center grinding wheel. The wheel was compressed at 5 ton/38 square inches (1.8 MegaPascals) to shape the disc. The bonded wheel was placed in an oven to cure for 7 hours at 79° C., 3 hours at 107° C., 18 hours at 185° C., and a temperature ramp-down over 4 hours to 27° C.

The dimensions of the final grinding wheel were 115 millimeter diameter×7 millimeter thickness. The center hole was ⅞ inch (2.2 centimeters) in diameter. A photo of the resulting grinding wheel is shown in FIG. 10.

### Example 4

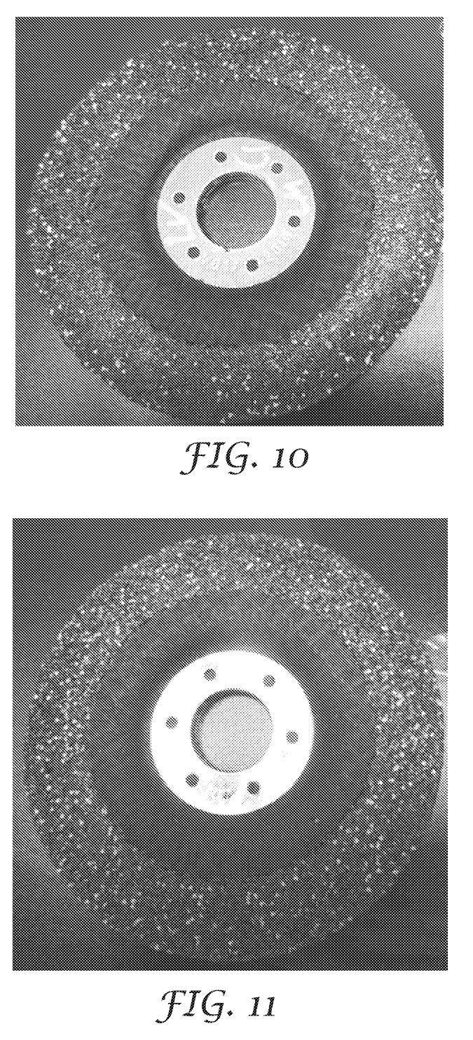

The procedure generally described in EXAMPLE 2 was repeated, with the exception that the colored bonded wheel was cured in an oven with the temperature programmed as follows: 3 hours at 90° C., ramp up to 120° C. for 2 hours and hold at 120° C. for 3 hours, ramp up to 150° C. for 3 hours, hold at 150° C. for 7 hours. Then the wheel was allowed to cool down naturally to approximately 23° C. A photo of the resulting grinding wheel is shown in FIG. 11.

The grinding wheels from Examples 1 through 4 and COMPARATIVE EXAMPLES A through D were tested according to the procedure described in “Grinding Test”. The test results were summarized in Table 2.

TABLE 2

| Example # | Total Cut (Grams) |
|---|---|
| EXAMPLE 1 | 266 |
| EXAMPLE 2 | 295 |
| COMPARATIVE EXAMPLE A | 256 |
| COMPARATIVE EXAMPLE B | 272 |
| COMPARATIVE EXAMPLE C | 170 |
| COMPARATIVE EXAMPLE D | 160 |
| EXAMPLE 3 | 389 |
| EXAMPLE 4 | 381 |

Various modifications and alterations of this disclosure may be made by those skilled in the art without departing from the scope and spirit of this disclosure, and it should be understood that this disclosure is not to be unduly limited to the illustrative embodiments set forth herein.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure.

### Additional Embodiments

The following exemplary embodiments are provided, the numbering of which is not to be construed as designating levels of importance:

Embodiment 1 provides a composite abrasive article comprising:

a first portion having a first color; and

a second portion having a second color different than the first color.

Embodiment 2 provides the composite abrasive article of Embodiment 1, wherein the article is a wheel.

Embodiment 3 provides the composite abrasive article of any one of Embodiments 1 or 2, wherein at least one of the first color and the second color are independently red, orange, yellow, green, blue, indigo, violet, white, gold, silver, or any combination thereof.

Embodiment 4 provides the composite abrasive article of any one of Embodiments 1-3, wherein the article further comprises:

optionally, a third portion having a third color different than the first and second colors; and

optionally, if the third portion is present, a fourth portion having a fourth color different than the first, second, and third colors.

Embodiment 5 provides the composite abrasive article of Embodiment 4, wherein the third color and the fourth color are independently red, orange, yellow, green, blue, indigo, violet, white, gold, silver, or any combination thereof.

Embodiment 6 provides the composite abrasive article of any one of Embodiments 1-5, wherein the first portion and the second portion are layers of the article.

Embodiment 7 provides the composite abrasive article of any one of Embodiments 1-6, wherein the first portion is an abrasive layer of the article.

Embodiment 8 provides the composite abrasive article of any one of Embodiments 1-7, wherein the second portion is a backing layer of the article.

Embodiment 9 provides the composite abrasive article of any one of Embodiments 1-8, wherein

the first portion comprises a first plurality of particles in a binder,

the second portion comprises a second plurality of particles in the binder,

if present, the third portion comprises a third plurality of particles in the binder, and,

if present, the fourth portion comprises a fourth plurality of particles in the binder.

Embodiment 10 provides the composite abrasive article of Embodiments 9, wherein at least one the first plurality of particles, the second plurality of particles, the third plurality of particles, and the fourth plurality of particles are randomly disturbed within the article.

Embodiment 11 provides the composite abrasive article of any one of Embodiments 4-10, wherein at least one of the first portion, the second portion, the third portion, and the fourth portion is about 2 wt % to about 50 wt % of the article.

Embodiment 12 provides the composite abrasive article of any one of Embodiments 4-10, wherein at least one of the first portion, the second portion, the third portion, and the fourth portion is about 10 wt % to about 25 wt % of the article.

Embodiment 13 provides the composite abrasive article of any one of Embodiments 9-12, wherein at least one of the first plurality of particles, the second plurality of particles, the third plurality of particles, and the fourth plurality of particles is about 2 wt % to about 50 wt % of the article.

Embodiment 14 provides the composite abrasive article of any one of Embodiments 9-13, wherein at least one of the first plurality of particles, the second plurality of particles, the third plurality of particles, and the fourth plurality of particles is about 10 wt % to about 25 wt % of the article.

Embodiment 15 provides the composite abrasive article of any one of Embodiments 9-14, wherein at least one of the first plurality of particles, the second plurality of particles, the third plurality of particles, and the fourth plurality of particles comprise shaped abrasive particles.

Embodiment 16 provides the composite abrasive article of any one of Embodiments 9-15, wherein the shaped abrasive particles of each of the first, second, third, and fourth plurality of particles have a shape that is substantially the same.

Embodiment 17 provides the composite abrasive article of any one of Embodiments 9-16, wherein a size of at least one of the first, second third, and fourth plurality of particles is different from that of another of the first, second, third, or fourth plurality of particles.

Embodiment 18 provides the composite abrasive article of any one of Embodiments 9-17, wherein at least one of the first plurality of particles, the second plurality of particles, the third plurality of particles, and the fourth plurality of particles has a different shape than the other pluralities of particles.

Embodiment 19 provides the composite abrasive article of any one of Embodiments 15-18, wherein a shape of at least one of the first plurality of particles, the second plurality of particles, the third plurality of particles, and the fourth plurality of particles is a truncated triangular pyramid.

Embodiment 20 provides the composite abrasive article of any one of Embodiments 9-19, wherein at least one of the first plurality of particles, the second plurality of particles, the third plurality of particles, and the fourth plurality of particles comprise conventional abrasive particles.

Embodiment 21 provides the composite abrasive article of any one of Embodiments 9-20, wherein at least one of the first plurality of particles, the second plurality of particles, the third plurality of particles, and the fourth plurality of particles comprise crushed abrasive particles.

Embodiment 22 provides the composite abrasive article of Embodiment 21, wherein a size of the crushed abrasive particles of at least one of the of the first, second third, and fourth plurality of particles have a size that is different from that of the first, second, third, or fourth plurality of particles.

Embodiment 23 provides the composite abrasive article of any one of Embodiments 9-22, wherein at least one of the first plurality of particles, the second plurality of particles, the third plurality of particles, and the fourth plurality of particles comprise filler particles.

Embodiment 24 provides the composite abrasive article of any one of Embodiments 9-23, wherein the binder comprises an organic binder.

Embodiment 25 provides the composite abrasive article of Embodiment 24, wherein the organic binder comprises a phenolic resin.

Embodiment 26 provides the composite abrasive article of any one of Embodiments 1-25, wherein at least one of the first portion and second portion comprises glitter.

Embodiment 27 provides the composite abrasive article of any one of Embodiments 2-26, wherein the wheel is at least one of a cut-off wheel, a cut-and-grind wheel, a depressed center grinding wheel, a depressed center cut-off wheel, a reel grinding wheel, a mounted point, a tool grinding wheel, a roll grinding wheel, a hot-pressed grinding wheel, a face grinding wheel, a grinding plug, a grinding cone, a rail grinding wheel, a cylindrical grinding wheel, and a double disk grinding wheel.

Embodiment 28 provides a method of making the composite abrasive article according to any one of Embodiments 1-27, comprising:

obtaining or providing a first mixture comprising:
a first plurality of particles having a first color,
an organic binder, and
an optional filler;

contacting the first mixture with a mold; and

pressing the mold, to provide the composite abrasive article of any one of Embodiments 1.

Embodiment 29 provides the method of Embodiment 28, and further comprising:

optionally, obtaining a second mixture comprising:
a second plurality of particles having a second color different than the first color; and
an organic binder;

optionally, obtaining a third mixture comprising:
a third plurality of particles having a third color different than the first color and the second color; and
an organic binder; and

optionally, obtaining a fourth mixture comprising:
a fourth plurality of particles having a fourth color different than the first color, the second color, and the third color; and
an organic binder; and

contacting the second mixture, third mixture, and the fourth mixture with the mold.

Embodiment 30 provides the method of Embodiment 29, further comprising mixing at least one of the first mixture, the second mixture, the third mixture, and the fourth mixture.

Embodiment 31 provides the method of any one of Embodiments 29-30, and further comprising adding at least one of a first coloring element, a second coloring element, a third coloring element, and a fourth coloring element to produce at least one of the respective first color, second color, third color, and fourth color.

Embodiment 32 provides the method of Embodiment 31, wherein at least one of the first coloring element, the second coloring element, the third coloring element, and the fourth coloring element comprises a pigment, glitter, a metal powder, a vapor coated metal powder, a deposited metal powder, or a combination thereof.

Embodiment 33 provides the method of Embodiment 32, wherein at least one of the first coloring element, second coloring element third coloring element, and fourth coloring element at least partially coats individual particles of at least one of the respective first plurality of particles, second plurality of particles, third plurality of particles, and fourth plurality of particles.

Embodiment 34 provides the method of any one of Embodiments 29-33, further comprising:

applying a compression force of about 1.5 MPa to about 2.0 MPa to at least one of the first, second, third, and fourth mixtures.

Embodiment 35 provides the method of any one of Embodiments 29-34, and further comprising:

heating at least one of the first, second, third, and fourth mixture at a temperature ranging up to about 195° C.

Embodiment 36 provides the method of Embodiment 35, wherein the heating comprises heating in an environment where the concentration of oxygen is lower than the concentration of oxygen in ambient conditions.

Embodiment 37 provides the method of any one of Embodiments 35 or 36, wherein the heating comprises heating at a temperature of up to about 165° C.

Embodiment 38 provides the method of any one of Embodiments 29-37, wherein a color of at least one of the first plurality of particles, second plurality of particles, third plurality of particles, and fourth plurality of particles is substantially changed after the mold is heated.

Embodiment 39 provides a method of using the composite abrasive article of any one of Embodiments 1-38, comprising:

contacting a surface and the composite abrasive article; and

moving the composite abrasive article with respect to the surface, to abrade the surface.

1. A composite abrasive article comprising:
a first portion having a first color; and
a second portion having a second color different than the first color.

2. (canceled)

3. The composite abrasive article of claim 1, wherein at least one of the first color and the second color are independently red, orange, yellow, green, blue, indigo, violet, white, gold, silver, or any combination thereof.

4. The composite abrasive article of claim 1, wherein the article further comprises:
optionally, a third portion having a third color different than the first and second colors; and
optionally, if the third portion is present, a fourth portion having a fourth color different than the first, second, and third colors.

5. (canceled)

6. The composite abrasive article of claim 1, wherein the first portion and the second portion are layers of the article, wherein the first portion is an abrasive layer and wherein the second portion is a backing layer.

7. (canceled)

8. The composite abrasive article of claim 1, wherein the second portion is a backing layer of the article.

9. The composite abrasive article of claim 1, wherein
the first portion comprises a first plurality of particles in a binder,
the second portion comprises a second plurality of particles in the binder,
if present, the third portion comprises a third plurality of particles in the binder, and,
if present, the fourth portion comprises a fourth plurality of particles in the binder.

10. (canceled)

11. The composite abrasive article of claim 4, wherein at least one of the first portion, the second portion, the third portion, and the fourth portion is about 2 wt % to about 50 wt % of the article.

12-14. (canceled)

15. The composite abrasive article of claim 9, wherein at least one of the first plurality of particles, the second plurality of particles, the third plurality of particles, and the fourth plurality of particles comprise shaped abrasive particles.

16. The composite abrasive article of claim 9, wherein the shaped abrasive particles of each of the first, second, third, and fourth plurality of particles have a shape that is substantially the same.

17-23. (canceled)

24. The composite abrasive article of claim 9, wherein the binder comprises an organic binder.

25-26. (canceled)

27. The composite abrasive article of claim 1, wherein the article is a wheel, and wherein the wheel is at least one of a cut-off wheel, a cut-and-grind wheel, a depressed center grinding wheel, a depressed center cut-off wheel, a reel grinding wheel, a mounted point, a tool grinding wheel, a roll grinding wheel, a hot-pressed grinding wheel, a face grinding wheel, a grinding plug, a grinding cone, a rail grinding wheel, a cylindrical grinding wheel, and a double disk grinding wheel.

28. A method of making the composite abrasive article according to claim 1, comprising:
obtaining or providing a first mixture comprising:
a first plurality of particles having a first color,
an organic binder, and
an optional filler;
contacting the first mixture with a mold; and
pressing the mold, to provide the composite abrasive article of claim 1.

29. The method of claim 28, and further comprising:
optionally, obtaining a second mixture comprising:
a second plurality of particles having a second color different than the first color; and
an organic binder;
optionally, obtaining a third mixture comprising:
a third plurality of particles having a third color different than the first color and the second color; and
an organic binder; and
optionally, obtaining a fourth mixture comprising:
a fourth plurality of particles having a fourth color different than the first color, the second color, and the third color; and
an organic binder; and
contacting the second mixture, third mixture, and the fourth mixture with the mold.

30. The method of claim 29, further comprising mixing at least one of the first mixture, the second mixture, the third mixture, and the fourth mixture.

31. The method of claim 29, and further comprising adding at least one of a first coloring element, a second coloring element, a third coloring element, and a fourth coloring element to produce at least one of the respective first color, second color, third color, and fourth color, wherein at least one of the first coloring element, the second coloring element, the third coloring element, and the fourth coloring element comprises a pigment, glitter, a metal powder, a vapor coated metal powder, a deposited metal powder, or a combination thereof.

32. (canceled)

33. The method of claim 31, wherein at least one of the first coloring element, second coloring element, third coloring element, and fourth coloring element at least partially coats individual particles of at least one of the respective first plurality of particles, second plurality of particles, third plurality of particles, and fourth plurality of particles.

34. The method of claim 29, further comprising:
applying a compression force of about 1.5 MPa to about 2.0 MPa to at least one of the first, second, third, and fourth mixtures.

35. The method of claim 29, and further comprising:
heating at least one of the first, second, third, and fourth mixtures at a temperature ranging up to about 195° C.

36. The method of claim 35, wherein the heating comprises heating in an environment where the concentration of oxygen is lower than the concentration of oxygen in ambient conditions.

37. (canceled)

38. The method of claim 29, wherein a color of at least one of the first plurality of particles, second plurality of particles, third plurality of particles, and fourth plurality of particles is substantially changed after the mold is heated.

39. A method of using the composite abrasive article of claim 1, comprising:
contacting a surface and the composite abrasive article; and
moving the composite abrasive article with respect to the surface, to abrade the surface.
